(19) United States
(12) Patent Application Publication
(10) Pub. No.: US 2025/0111382 A1
(43) Pub. Date: Apr. 3, 2025

(54) Anti-Greenwashing Carbon Data Aggregation and Disaggregation

(71) Applicant: Cisco Technology, Inc., San Jose, CA (US)

(72) Inventors: Quynhnhu Doan, Houston, TX (US); Anna Bennett, Harker Heights, TX (US); Davide Pacifico, Pescara PE (IT); Chris Adams, Hampshire (GB)

(21) Appl. No.: 18/478,435

(22) Filed: Sep. 29, 2023

(51) Int. Cl. G06Q 30/018; H04L 9/40

(52) U.S. Cl. CPC G06Q 30/018; H04L 63/0442

(57) ABSTRACT

Described herein are devices, systems, methods, and processes for assessing and managing the carbon footprint of information technology (IT) infrastructures. The system can utilize distributed public key infrastructure (PKI) to ensure data security, trustworthiness, and anonymity. It may provide real-time, accurate, and comprehensive data on the carbon footprint of the entire infrastructure, enabling administrators to make informed decisions based on live, aggregated, and anonymized power consumption data and carbon footprint metrics. The system can also support the management of carbon-related metrics during processes such as device migration or infrastructure renewal. Furthermore, it can enable various stakeholders, including IT infrastructure owners, auditors, and generic users, to access and analyze the data based on their specific roles and permissions. This approach can enhance the transparency and accountability of IT operations, contributing to environmental sustainability efforts in the IT industry.

The present disclosure relates to environmental sustainability in information technology (IT) operations. More particularly, the present disclosure relates to transparently assessing and optimizing the carbon footprint of network infrastructures.

### BACKGROUND

The information technology (IT) industry is a significant contributor to global greenhouse gas (GHG) emissions and carbon dioxide (“carbon” for short) emissions, with its impact comparable to that of the entire airline industry. Despite efforts by device manufacturers and vendors to reduce the carbon footprint of their products, there remains a lack of transparency and insight into carbon-related metrics. The lack of visibility can hinder users from understanding their own GHG and carbon footprint, thereby limiting their ability to make informed decisions regarding their IT infrastructure management.

Current solutions in the industry often provide power usage data for individual devices. However, this approach may fail to provide a comprehensive view of the respective carbon footprint for such devices and for the entire IT infrastructure as a whole, which can include numerous devices of various types and generations. This piecemeal approach may make it difficult for administrators to assess the overall environmental impact of their operations and to identify opportunities for improvement.

Furthermore, much of the data provided by existing solutions can be static, based on manufacturer specifications or laboratory measurements rather than real-world usage, which can result in inaccuracies in the carbon footprint assessment. Actual power consumption can vary significantly depending on factors such as device configuration, workload, and operating conditions. Additionally, verifying the consumption and emission claims made by manufacturers or vendors can be challenging. Without a reliable and secure method of data verification, users may have doubts about the accuracy and trustworthiness of the provided information. These challenges underscore the need for improved solutions in IT infrastructure management, particularly in relation to sustainability.

### SUMMARY OF THE DISCLOSURE

Systems and methods for transparently assessing and optimizing the carbon footprint of network infrastructures in accordance with embodiments of the disclosure are described herein. In some embodiments, a network device, includes a processor, at least one network interface controller configured to provide access to a network, and a memory communicatively coupled to the processor, wherein the memory includes environmental sustainability logic. The logic is configured to receive data from a plurality of data sources, the plurality of data sources including one or more devices of an information technology (IT) infrastructure, generate derivative data based at least in part on the received data, generate carbon emission-related presentable data for a user based on the received data and/or the derivative data, and transmit the carbon emission-related presentable data to another device to be presented to the user.

In some embodiments, the received data includes first data associated with a first device in the one or more devices, and the environmental sustainability logic is further configured to verify authenticity of the first data based on a first public key associated with the first device and a first cryptographic signature associated with the first data.

In some embodiments, the environmental sustainability logic is further configured to verify the authenticity of the first data based on a second public key associated with an owner or administrator of the IT infrastructure and a second cryptographic signature associated with the first data.

In some embodiments, the environmental sustainability logic is further configured to discard the first data in response to failing to verify the authenticity of the first data.

In some embodiments, the environmental sustainability logic is further configured to store the first data in a datastore in response to successfully verifying the authenticity of the first data.

In some embodiments, the derivative data is generated based at least in part on the stored first data, and the environmental sustainability logic is further configured to store the derivative data in the datastore.

In some embodiments, the datastore is associated with a distributed public key infrastructure.

In some embodiments, the datastore includes a data section and a claims section.

In some embodiments, the first data includes one or more carbon-related metrics associated with the first device.

In some embodiments, the received data includes second data associated with at least one power source for the IT infrastructure.

In some embodiments, the derivative data includes aggregated data.

In some embodiments, the aggregated data is associated with aggregation based on at least one of the one or more devices, one or more network layers, one or more geographical areas, or one or more power source types.

In some embodiments, the derivative data further includes one or more statistics associated with the aggregated data.

In some embodiments, the aggregated data is anonymized.

In some embodiments, the environmental sustainability logic is further configured to receive a user query associated with the user, and identify an identity of the user based at least in part on a public key associated with the user, and wherein the carbon emission-related presentable data is generated for the user based further on the identified identity of the user.

In some embodiments, the identity of the user corresponds to an owner or administrator of the IT infrastructure.

In some embodiments, the identity signed utilizing a private key of an owner or administrator of the IT infrastructure.

In some embodiments, the carbon emission-related presentable data includes disaggregated data associated with disaggregation based on the identity of the user.

In some embodiments, a user device, includes a processor, at least one network interface controller configured to provide access to a network, and a memory communicatively coupled to the processor, wherein the memory includes environmental sustainability logic. The logic is configured to receive a user input corresponding to a user query from a user, transmit the user query to a network device, the user query being associated with a cryptographic signature, receive carbon emission-related presentable data from the network device, and present the carbon emission-related presentable data to the user.

In some embodiments, a method for providing carbon emission data includes receiving data from a plurality of data sources, the plurality of data sources including one or more devices of an information technology infrastructure, generating derivative data based at least in part on the received data, generating carbon emission-related presentable data for a user based on the received data and/or the derivative data, and transmitting the carbon emission-related presentable data to another device to be presented to the user.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a schematic diagram of a network with network devices powered by various power source types in accordance with an embodiment of the disclosure;

FIG. 2 is a diagram illustrating different types of public key infrastructure (PKI) in accordance with various embodiments of the disclosure;

FIG. 3 is a diagram illustrating different personas interacting with the stored carbon-related metrics utilizing a distributed PKI in accordance with various embodiments of the disclosure;

FIG. 4 is a diagram illustrating the utilization of the key pair by personas to maintain identification and authenticate data in accordance with various embodiments of the disclosure;

FIG. 5 is a comprehensive system diagram illustrating the interaction between various modules and a network/information technology (IT) infrastructure in accordance with various embodiments of the disclosure;

FIG. 6 is a diagram illustrating the implementation of a datastore in accordance with various embodiments of the disclosure;

FIG. 7 is a diagram illustrating the process of assessing the carbon footprint of an IT infrastructure during device migration in accordance with various embodiments of the disclosure;

FIG. 8 is a flowchart showing a process for generating and transmitting carbon emission-related data in accordance with various embodiments of the disclosure;

FIG. 9 is a flowchart showing a process for receiving, verifying, and storing data in accordance with various embodiments of the disclosure;

FIG. 10 is a flowchart showing a process for generating and transmitting carbon emission-related data based on a user identity in accordance with various embodiments of the disclosure is shown;

FIG. 11 is a flowchart showing a process for responding to a user query and presenting carbon emission-related data in accordance with various embodiments of the disclosure; and

FIG. 12 is a conceptual block diagram for one or more devices capable of executing components and logic for implementing the functionality and embodiments described above.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted to facilitate a less obstructed view of these various embodiments of the present disclosure.

### DETAILED DESCRIPTION

In response to the issues described above, devices and methods are discussed herein that provide visibility and insights into carbon-related metrics (also referred to hereinafter as “carbon metrics” or “carbon footprint metrics”) of information technology (IT) devices in operation. The techniques may involve ingesting relevant carbon footprint metrics from various sources, providing live aggregated data in a trustworthy manner, and securely disaggregating a selectable set of carbon-related data sets associated with a user.

In many embodiments, a platform (e.g., provided by device manufacturers/vendors) may securely ingest relevant carbon footprint metrics from various sources. The sources can include data from the devices themselves and additional data, such as, but not limited to, data provided by an administrator. In a number of embodiments, the relevant carbon footprint metrics may comprise device power consumption, subsystem power need, central processing unit (CPU) load, network load, operating system, and/or hardware and/or software configuration. Additional data can also include the physical location (i.e., geolocation/geolocalization) and/or power source of the devices.

In a variety of embodiments, live aggregated data can be provided in a trustworthy manner. The data may be cryptographically (digitally) signed with hardware-based keys, enabling dynamic benchmarking, analysis, and real-time insights about carbon-related metrics. In some embodiments, live aggregated data can be utilized for the dynamic benchmarking and analysis of the carbon-related metrics. It can also be used to compare a device and/or a multi-layer IT infrastructure against similar deployments in the industry.

In more embodiments, a selectable set of carbon-related data sets associated with a user may be securely disaggregated. The disaggregated data set may be exposed just to the specific user. In additional embodiments, the secure disaggregation of data sets can be performed according to delegated authorization. This may allow a user to delegate access to an auditor.

In further embodiments, a distributed public key infrastructure (PKI) may be leveraged for attestation and verification. In still other embodiments, the distributed PKI can be implemented as a datastore providing the same or improved level of security as a traditional PKI maintained by a certification authority. In further embodiments, the comparison of live results published by a manufacturer/vendor against the same carbon-related metrics from the source may be allowed. In further additional embodiments, this can enable a regulator to compare and verify the results at the source against the disaggregated data obtained from the manufacturer/vendor.

In summary, device manufacturers/vendors can expose and provide live aggregated data about carbon-related metrics in a trustworthy manner. Furthermore, a selectable set of carbon-related data sets associated with a user can be securely disaggregated. As previously stated, the disaggregated data sets may be exposed just to the specific user. This may enable users to understand their own greenhouse gas (GHG) and carbon footprint and make informed decisions.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.” Furthermore, aspects of the present disclosure may take the form of a computer program product embodied in one or more non-transitory computer-readable storage media storing computer-readable and/or executable program code. Many of the functional units described in this specification have been labeled as ‘functions’, in order to emphasize their implementation independence more particularly. For example, a function may be implemented as a hardware circuit comprising custom very large-scale integration (VLSI) circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

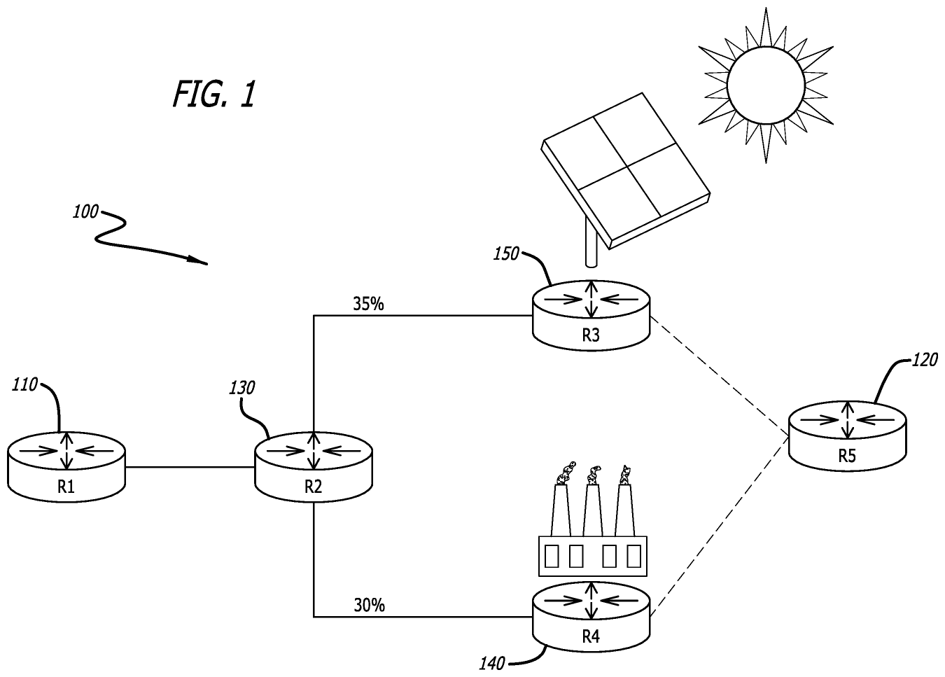

Referring to FIG. 1, a schematic diagram of a network 100 with network devices powered by various power source types in accordance with an embodiment of the disclosure is shown. Network 100 can include a plurality of devices, e.g., routers 110, 130, 140 and 150, which can be in communication with each other and/or a remote server, such as a cloud-based server 120. The network 100 depicted in FIG. 1 is shown as a simplified, conceptual network. Those skilled in the art will understand that a network 100 can include a large variety of devices and be arranged in a virtually limitless number of combinations based on the desired application and available deployment environment.

Additionally, it is recognized that the terms “power” and “energy” are often used interchangeably in many colloquial settings but have distinct differences. Specifically, energy is accepted as the capacity of a system or device to do work (such as in kilowatt-hours (kWh)), while power is the rate at which energy is transferred (often in watts (W)). Power represents how fast energy is being used or produced. With this in mind, it should be understood that various elements of the present disclosure may utilize common terms like “power lines,” “power grids,” power source,” “power consumption,” and “power plant” when describing energy delivery and utilization, even though those skilled in the art will recognize that those elements are delivering or processing energy (specifically electricity) at a certain rate of power. References to these terms are utilized herein specifically to increase the ease of reading.

Traditionally, devices operating within a network 100 have not considered various aspects of operation that can relate to the overall sustainability of the network. For example, devices in communication networks have often used grid-supplied energy as a primary power source. This grid-supplied energy can regularly provide energy that has been generated by a negative environmental impact-heavy power source such as a coal-powered power plant. However, modern power grids often have more diverse and cleaner energy sources for the provided generated energy. Some devices can still be powered by power sources that utilize fossil fuels, such as the router R4 140 as depicted in FIG. 1. Alternatively, some devices can operate by using renewable sources of energy, such as the router R3 150 which is conceptually depicted as being powered by solar power.

Those skilled in the art will recognize that the generation of electricity within the various power plants often creates some pollution or, more generally, one or more negative environmental impacts, which can often come in the form of emissions. However, these negative environmental impacts can come in a variety of forms including, but not limited to, land use, ozone depletion, ozone formation inhibition, acidification, eutrophication (freshwater, marine, and terrestrial), abiotic resource depletion (minerals, metals, and fossil fuels), toxicity, water use, negative soil quality change, ionizing radiation, hazardous waste creation, etc. As such, these negative environmental impact measurements can be measured with specific units to quantify these changes. Various aspects of energy use can be associated with one or more of these negative environmental impacts and classified as one or more sustainability-related attributes.

In the embodiment depicted in FIG. 1, the operation of a coal-powered power plant will create a sizeable amount of negative environmental impacts in the form of carbon emissions and the like. Contrast that with a solar array which may not create emissions when generating electricity, but may cause negative environmental impacts, such as carbon emission generation, associated with the production and/or disposal of the solar array. Various methods of measuring these negative environmental impacts may occur. One measurement may be to examine the waste products created by the power generated (such as nuclear waste, vs. solar array e-waste, etc.).

Another measurement of negative environmental impacts that can be utilized when comparing power sources is to determine the amount of greenhouse or carbon emissions released per unit of electricity generated. Specifically, various embodiments described herein may utilize the CO₂e kg/kWh metric which measures the amount of kilowatt hours produced per kilogram of carbon dioxide gases released into the environment. Therefore, when discussing a negative environmental impact-heavy power source compared to a clean(er) power source, the clean power source can, for example, have a better CO₂e kg/kWh rating compared to the negative environmental impact-heavy power source. Utilizing a cleaner power source thus provides for a more sustainable network operation.

In order the maximize the overall sustainability of a network, it may be desirable to increase the use of cleaner power sources with a lower overall negative environmental impact as opposed to power sources with a higher overall negative environmental impact when operating the network. Thus, there can be a need to be aware of the source of energy provided at each device along the route of data travel. Additionally, other factors such as the attributes unique to each device can be factored in, along with the current and/or expected traffic, etc. Once known, an optimal method of traversing the data may need to be calculated. As discussed in more detail, this path algorithm can be utilized to better optimize the locations selected within a network for data travel.

Other methods may be utilized to increase sustainability in network operations. In many embodiments, the network devices themselves may have one or more features or other capabilities that can allow for a more efficient operation. For example, a network router may be operated in a lower power mode or be powered off entirely for a specific period or until an event occurs. Additional embodiments may utilize various other power-saving capabilities that can be turned on or off remotely or in response to an event or predetermined threshold being exceeded. Often, operations performed by the network devices can be utilized in scenarios where network performance will not be affected or is affected such that no loss in user experience occurs. By utilizing less power during operation, a higher level of sustainability can be achieved.

Together, the type of power source providing electricity to a network device, along with the various sustainability-related capabilities of the router can be understood as the sustainability-related attributes of that network device. During operation, one or more devices within the network may seek and collect the sustainability-related attributes of various network devices, which can provide insight into both the type of power source providing power to the device, but also the various capabilities of the network device that may be activated to provide more efficient operation.

Additionally, when generating various scores, metrics, or other evaluations of the network devices within a network 100, the sustainability-related attributes can vary based on a variety of factors such as the time of day, current network traffic, expected network traffic, and historical usage patterns. For example, a network router may receive energy from a solar power source during the day but receives energy from a coal-powered power plant at night. In these instances, an averaged score may be used, or a unique score may be generated at the time of operation. In another example, network traffic may be such that removing one or more network devices from the optimal sustainable data paths may negatively affect user experiences, such as when a sporting event occurs. As such, scores may be generated at numerous times depending on the desired application. Often, the act of measurement may negatively affect sustainability such that determining the proper number of measurements for a given outcome may be determined.

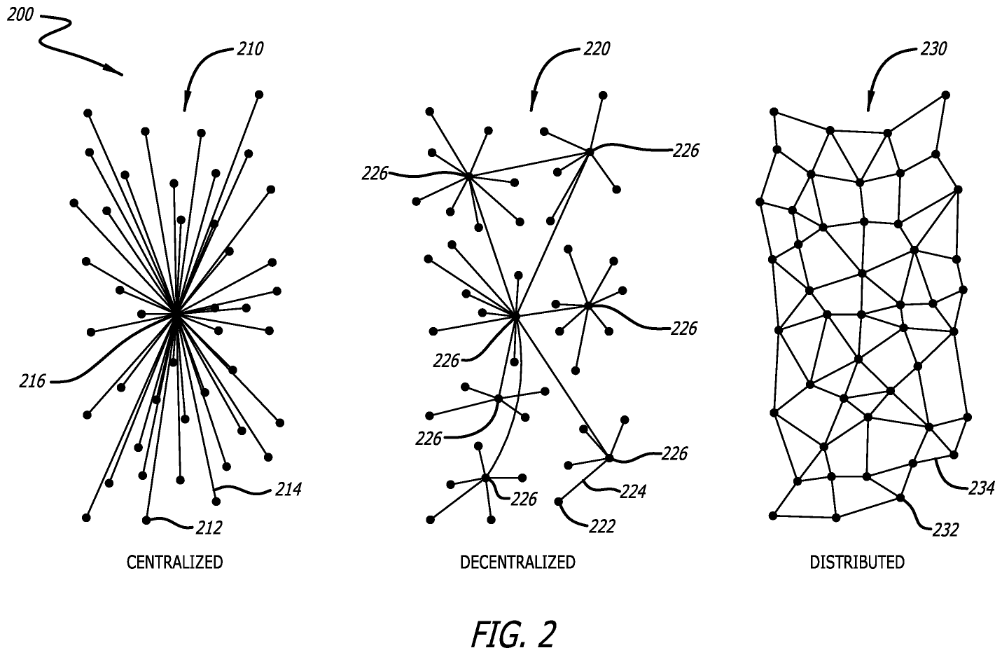

Although a specific embodiment for a network 100 is described above with respect to FIG. 1, any of a variety of systems and/or processes may be utilized in accordance with embodiments of the disclosure. For example, the network could be broken into a plurality of partitions, wherein each partition could have specific needs, service level agreements, etc. that can alter sustainability-optimization. The elements depicted in FIG. 1 may also be interchangeable with other elements of FIGS. 2-12 as required to realize a particularly desired embodiment. Augmented protocols to carry out these described processes are described below.

Referring to FIG. 2, a diagram 200 illustrating different types of PKI in accordance with various embodiments of the disclosure is shown. In the embodiments shown in FIG. 2, a graph 210 shows a centralized PKI, a graph 220 shows a decentralized PKI, and a graph 230 shows a distributed PKI. In many embodiments, the graph 210 represents a centralized PKI. A centralized PKI may include multiple stations 212 interconnected by links 214. In a centralized PKI, a single, main authority 216, such as, but not limited to a certification authority, can manage the entire infrastructure. The authority may be responsible for issuing, revoking, and managing all the certificates. While the centralized approach can provide a high level of control and consistency, it may also present a single point of failure, making the entire infrastructure vulnerable if the central authority is compromised.

In a number of embodiments, the graph 220 depicts a decentralized PKI. A decentralized PKI may include stations 222 interconnected by links 224. In a decentralized PKI, multiple authorities 226 can share the responsibilities of managing the infrastructure. This can provide a higher level of resilience compared to a centralized PKI (e.g., as shown as the graph 210), as the compromise of one authority may not necessarily affect the entire infrastructure. However, coordination and consistency across the different authorities can be challenging.

In a variety of embodiments, the graph 230 illustrates a distributed PKI. A datastore based on a distributed PKI can represent an application-specific distributed ledger. The distributed PKI can be used in the context of self-sovereign identity. It may rely on a distributed ledger enabling a wide spectrum of zero-knowledge proof (ZKP) techniques without exposing the identity data. Non-limiting examples of ZKP techniques may include, but may not be limited to, proving, and verifying properties such as ownership (e.g., crypto currencies), financial balances, or age above 18, etc., without exposing the identity data. The distributed PKI in combination with forward signing can enable attestations and/or provable verifications. As shown, a distributed PKI may include stations 232 interconnected by links 234. In a distributed PKI, like the one utilized in various embodiments of the disclosure, the responsibilities of managing the infrastructure can be distributed across all the nodes (e.g., the stations 232) in the network. This can provide a high level of resilience and security, as there is no single point of failure. Moreover, it can offer a high level of transparency and trustworthiness, as all nodes may participate in the management of the infrastructure. However, maintaining synchronization and consensus among all nodes can be technically challenging.

Although a specific embodiment for different types of PKI suitable for carrying out the various steps, processes, methods, and operations described herein is discussed with respect to FIG. 2, any of a variety of systems and/or processes may be utilized in accordance with embodiments of the disclosure. For example, a hybrid PKI can be implemented, combining the characteristics of centralized, decentralized, and distributed infrastructures to provide a balance between control, resilience, and transparency. The elements depicted in FIG. 2 may also be interchangeable with other elements of FIGS. 1 and 3-12 as required to realize a particularly desired embodiment.

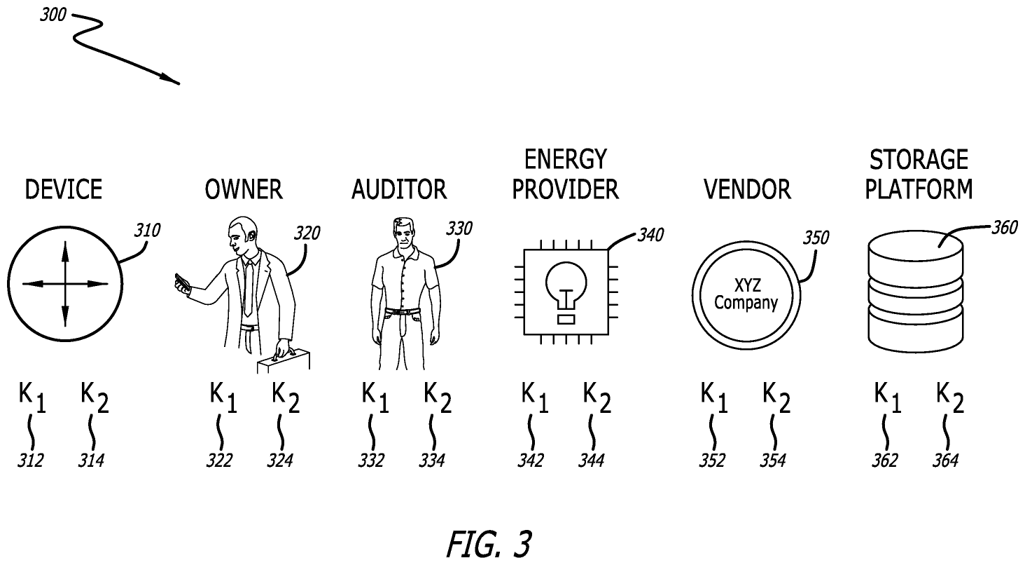

Referring to FIG. 3, a diagram 300 illustrating different personas interacting with the stored carbon-related metrics utilizing a distributed PKI in accordance with various embodiments of the disclosure is shown. The embodiments depicted in FIG. 3 include personas such as a device 310, an owner (or administrator) 320 (e.g., an owner/administrator of the IT infrastructure), an auditor 330, an energy provider 340, a vendor 350, and a storage platform 360. Each persona may have a corresponding identity, represented by a pair of keys: a public key (K1) and a private key (K2) (i.e., an asymmetric key pair). In many embodiments, an identity may be persistent (e.g., for devices), or may be temporary/for a single use (e.g., for auditors or delegated users). In a number of embodiments, the device 310 may be an IT device that generates carbon footprint metrics. The device 310 can have a public key K1 312 and a private key K2 314. The public key K1 312 may be utilized by other personas to authenticate cryptographic signatures generated by the device 310, while the private key K2 314 can be utilized by the device 310 to generate cryptographic signatures and sign data or messages (e.g., to initiate a chain of trust). In a variety of embodiments, the identity of the device 310 may be provisioned and stored in the hardware of the device 310 (e.g., during the manufacturing process (on “day −2”) or performed by the customer).

In some embodiments, the owner 320 may be the entity that owns the IT infrastructure that includes the device 310. The owner 320 can have a public key K1 322 and a private key K2 324. The public key K1 322 may be utilized by other personas to authenticate cryptographic signatures generated by the owner 320, while the private key K2 324 can be utilized by the owner 320 to generate cryptographic signatures and sign data or messages.

In more embodiments, the auditor 330 may be an entity that verifies the carbon footprint metrics. The auditor 330 can have a public key K1 332 and a private key K2 334. The public key K1 332 may be utilized by other personas to authenticate cryptographic signatures generated by the auditor 330, while the private key K2 334 can be utilized by the auditor 330 to generate cryptographic signatures and sign data or messages. Accordingly, other personas may authenticate the identity of the auditor 330 based on the public key K1 332 and a signature generated by the auditor 330 based on the private key K2 334.

In additional embodiments, the energy provider 340 may be the entity that provides energy to the IT infrastructure including the device 310. The energy provider 340 may have a public key K1 342 and a private key K2 344. The public key K1 342 can be utilized by other personas to authenticate cryptographic signatures generated by the energy provider 340, while the private key K2 344 may be utilized by the energy provider 340 to generate cryptographic signatures and sign data or messages.

In further embodiments, the vendor 350 may be the entity that manufactures or sells the device 310. The vendor 350 can have a public key K1 352 and a private key K2 354. The public key K1 352 can be utilized by other personas to authenticate cryptographic signatures generated by the vendor 350, while the private key K2 354 may be utilized by the vendor 350 to generate cryptographic signatures and sign data or messages.

In still more embodiments, the storage platform 360 may be the entity that stores the carbon footprint metrics. The storage platform 360 can have a public key K1 362 and a private key K2 364. The public key K1 362 may be utilized by other personas to authenticate cryptographic signatures generated by the storage platform 360, while the private key K2 364 can be utilized by the storage platform 360 to generate cryptographic signatures and sign data or messages.

Although a specific embodiment for different personas interacting with the stored carbon-related metrics utilizing a distributed PKI suitable for carrying out the various steps, processes, methods, and operations described herein is discussed with respect to FIG. 3, any of a variety of systems and/or processes may be utilized in accordance with embodiments of the disclosure. For example, additional personas such as regulators or third-party service providers can be incorporated into the system, each with their own unique pair of keys. The elements depicted in FIG. 3 may also be interchangeable with other elements of FIGS. 1, 2, and 4-12 as required to realize a particularly desired embodiment.

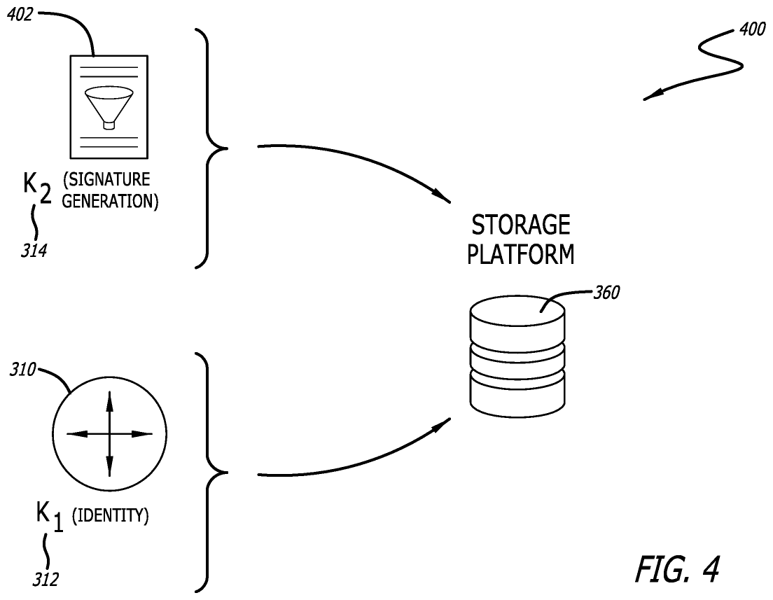

Referring to FIG. 4, a diagram 400 illustrating the utilization of the key pair by personas to maintain identification and authenticate data in accordance with various embodiments of the disclosure is shown. The embodiments depicted in FIG. 4 may utilize the device 310 as an example. In many embodiments, the device 310 may generates data 402, which can be carbon-related metrics or other relevant data. The data 402 can then be signed by the device 310 utilizing the device's private key K2 314. The use of the private key K2 314 for signing can ensure that the data is authenticated and originates from the device 310. The signed data can then be securely stored at the storage platform 360.

In a number of embodiments, the public key K1 312 of the device 310 can also be stored at the storage platform 360. The public key K1 312 can be used by other personas, such as the owner 320, auditor 330, energy provider 340, or vendor 350, to authenticate the signature on the data 402. By verifying the signature using the public key K1 312, these other personas can confirm that the data 402 indeed originates from the device 310 and has not been tampered with.

Although a specific embodiment for utilization of the key pair by personas to maintain identification and authenticate data suitable for carrying out the various steps, processes, methods, and operations described herein is discussed with respect to FIG. 4, any of a variety of systems and/or processes may be utilized in accordance with embodiments of the disclosure. For example, additional security measures such as, but not limited to, timestamping or hashing can be incorporated into the data signing process to further enhance data integrity and authenticity. The elements depicted in FIG. 4 may also be interchangeable with other elements of FIGS. 1-3 and 5-12 as required to realize a particularly desired embodiment.

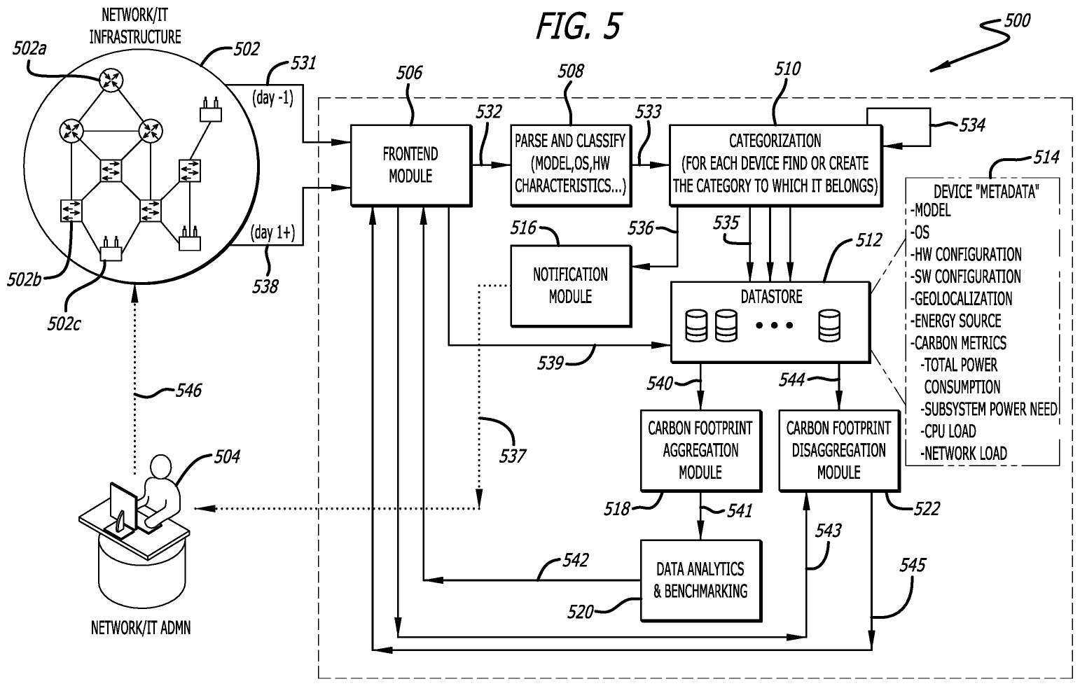

Referring to FIG. 5, a comprehensive system diagram 500 illustrating the interaction between various modules and a network/IT infrastructure in accordance with various embodiments of the disclosure is shown. In many embodiments, at 531, a multi-layer IT infrastructure 502 comprising several devices such as, but not limited to, routers 502a, switches 502b, access points 502c, and/or servers may send registration requests and associated metadata to a frontend module 506 (which may reside in a specialized device or exist as a cloud-based service). The multi-layer IT infrastructure 502 can belong or be managed by a user (e.g., the network/IT administrator 504). In a number of embodiments, the registration process can involve the user accepting certain terms and conditions to push relevant metadata for each device to the manufacturer/vendor, and may involve bidirectional authentication leveraging hardware-based keys on the device side. In a variety of embodiments, the metadata received by the manufacturer/vendor may be signed by the devices and bound to a specific user identifier (ID). A distributed PKI can be leveraged to provide the level of trust needed for auditing and certification. In some embodiments, the user may configure the devices or may rely on automated/zero-touch onboarding so that the devices can register with the manufacturer/vendor (e.g., during license activation processes, onboarding processes, etc.).

In more embodiments, at 532, the frontend module 506 may receive the registration request and associated metadata and may pass it to a parse and classify module 508. At 533, the parse and classify module 508 can parse and classify the metadata per device model, interfaces installed, capabilities, operating system, relevant configuration, etc. In additional embodiments, an administrator of the IT infrastructure may provide additional pointers and/or metadata, such as, but not limited to, geolocation and filter specific carbon metrics that the user is willing to share. In further embodiments, details about the energy source powering each device can be ingested if known. Alternatively, pointers from which such data can be retrieved can be provided if such data may be obtained directly from the utility company providing the energy (e.g., by plugging in the data reporting mechanism provided by the utility company). In still more embodiments, a normalization process can be implemented, so that the aggregated data may expose factors about how such data is captured by the system. By way of a non-limiting example, error factors can vary depending on whether the data comes from the utility provider, Energy Maps (e.g., data relating to geographical distribution of energy use, types of energy sources used in specific areas, and/or the carbon footprint associated with different energy sources, etc.), or an administrator. In still further embodiments, standard deviations on the data exposed can be considered.

In still additional embodiments, at 534, the parsed data may be further processed by a categorization module 510. The categorization module 510 can verify various IDs, such as, but not limited to, the device's ID, the user ID, etc., and can, for each device, either create a new device category entry (e.g., if a device does not belong in existing device categories in the datastore 512) or add an additional entry (including an ID assigned to the device) to an existing device category. At 535, the categorized data may then be stored in the datastore 512. As will be described in further detail below, the datastore 512 can be implemented in such a way as to maintain the chain of trust and provide effective delegated access. In some more embodiments, at 536, a notification module 516 may be triggered to send a notification to the network/IT administrator 504 at 537, indicating successful registration. This can complete the onboarding/registration process (e.g., in “day −1”).

In certain embodiments, at 538, one or more registered devices in the multi-layer IT infrastructure 502 may start sending signed carbon metrics to the manufacturer/vendor. At 539, the signed data can be pushed to the relevant datastore 512, and the device entry therein based on the metadata 514. In yet more embodiments, the device metadata 514 may include or indicate one or more of a device model, an operating system, a hardware configuration, a software configuration, a geolocalization, and/or one or more carbon metrics such as, but not limited to, a total power consumption, a subsystem power need, a central processing unit (CPU) load, and/or a network load.

In still yet more embodiments, at 540, a carbon footprint aggregation module 518 may take the data stored in the datastore 512 (e.g., for each of the device categories) and may anonymize, forward sign, and aggregate the corresponding carbon footprint metrics. In many further embodiments, multiple visibility functions may be utilized at this stage. By way of a non-limiting example, such aggregation may be done at single device level. By way of another non-limiting example, the aggregation may also be done at single layer level (e.g., at just the Layer 2 (L2) or Layer 3 (L3) level). In many additional embodiments, the aggregation may include elements fulfilling a custom rule (e.g., devices in a particular country, or devices powered by a specific type of power source, etc.). The aggregation may also include elements across various layers concurrently (e.g., Layer 1 (L1), L2, L3, and/or severs, etc.). At 541, the aggregated data can then be sent to a data analytics and benchmarking module 520.

In still yet further embodiments, at 542, the data analytics and benchmarking module 520 (e.g., being fed by different aggregation functions) may perform profiling and may enable benchmarking and analysis within and/or across the different aggregated carbon-related data sets. By way of non-limiting examples, the data analytics and benchmarking module 520 can compute maximum and minimum metrics and/or patterns, infer nominal carbon related metrics, and/or detect outliers, etc. The results can then be sent back to the frontend module 506. In still yet additional embodiments, the data may be exposed as “live” data signed by the manufacturer/vendor, thereby reflecting metrics from devices and network infrastructures deployed in the field.

In several embodiments, the data may be made available to different groups within the device manufacturer and/or vendor itself, as well as to the users, partners, authorities, and/or auditors, etc. (e.g., depending on delegation policies). By way of a non-limiting example, partner delegated access may enable a third party to prioritize a specific vendor over others. By way of another non-limiting example, auditor delegated access may represent the anchor point for verification against possible greenwashing allegations. By way of yet another non-limiting example, such data may be dynamically integrated to create a “live carbon datasheet,” enabling greater accuracy and transparency on the carbon footprint reporting of an operational multi-layer IT device.

In several more embodiments, at 543, a carbon footprint disaggregation module 522 may receive requests from the frontend module 506, which may be based on user requests (e.g., requests from the network/IT administrator 504). At 544, the carbon footprint disaggregation module 522 can retrieve data from the datastore 512 based on the requests. At 545, the carbon footprint disaggregation module 522 may disaggregate the carbon footprint data and send the disaggregated data back to the frontend module 506. Accordingly, the “live” and aggregated data view may enable an administrator to compare against similar deployments in the industry. To this end, an administrator with appropriate credentials may request access to the carbon footprint data (e.g., through a disaggregation carbon footprint module) associated with the IT infrastructure and devices under his/her administration. In numerous embodiments, the user (e.g., the administrator) may be enabled to configure custom rules (e.g., with the purpose of driving informed decisions). The requested “live” carbon metrics can be compared against the benchmarks shown, e.g., in the frontend module 506. At 546, if the access privilege is confirmed, the network/IT administrator 504 can then access the disaggregated data. In numerous additional embodiments, an auditor or a regulator may also verify the “live” results published by the manufacturer/vendor based on having access to the same carbon-related metrics from the source. By way of a non-limiting example, a regulator may be exposed to various IT installations and may be able to compare and verify the results at the source (e.g., obtainable directly from the equipment) against the disaggregated data obtained from the manufacturer/vendor. In further additional embodiments, a user may be alerted (and/or action recommendation provided) through the frontend module 506 and/or the notification module 516 if a carbon-related metric exceeds a threshold (the threshold may be configured, or may be identified based on machine learning techniques or similar). In some more embodiments, the various modules illustrated in FIG. 5 may be implemented in a centralized fashion or in a distributed fashion.

Although a specific embodiment for an overall system suitable for carrying out the various steps, processes, methods, and operations described herein is discussed with respect to FIG. 5, any of a variety of systems and/or processes may be utilized in accordance with embodiments of the disclosure. For example, additional modules for tasks such as data encryption or error detection could be incorporated into the system to further enhance data security and reliability. The elements depicted in FIG. 5 may also be interchangeable with other elements of FIGS. 1-4 and 6-12 as required to realize a particularly desired embodiment.

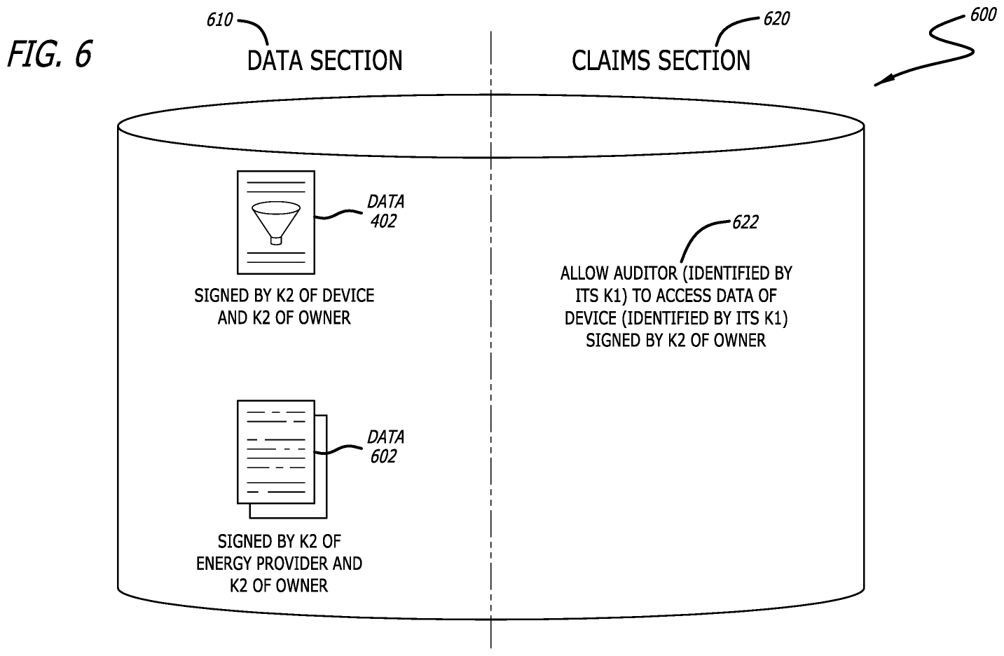

Referring to FIG. 6, a diagram illustrating the implementation of a datastore 600 in accordance with various embodiments of the disclosure is shown. The datastore 600 may be structured into two sections: a data section 610 and a claims section 620. In many embodiments, the data section 610 may store telemetry data related to devices, energy providers, and/or other systems contributing to the assessment of the carbon footprint of the IT infrastructure. The data can be double signed by the entity producing the data and the IT infrastructure owner to maintain a chain of trust (e.g., the IT infrastructure owner may verify the signature generated by the device before appending the signature of the owner). In a number of embodiments, the signed data can relate to, by way of non-limiting examples, hardware/software configuration topology details and other telemetry data related to the device. In a variety of embodiment, when integrating additional publicly available data such as the energy mix or detailed energy source measurement, the additional publicly available data may be signed by a different set of entities so as to avoid interference between different data sources. In the embodiments depicted in FIG. 6, the data section 610 may store two pieces of data: The first piece of data 402 may have been signed based on the private key K2 314 of the device 310 and the private key K2 324 of the owner 320 and the second piece of data 602 may have been signed based on the private key K2 344 of the energy provider 340 and the private key K2 324 of the owner 320. The double/dual signature mechanism can ensure the authenticity and integrity of the data, as it can be verified by the corresponding public keys. By way of a non-limiting example, for first data (e.g., the first piece of data 402) associated with a first device (e.g., the device 310), authenticity of the first data can be verified based on a first public key associated with the first device and a first cryptographic signature associated with the first data (the first cryptographic signature being generated utilizing the private key associated with the first device). The authenticity of the first data can further be verified based on a second public key associated with an owner or administrator of the IT infrastructure and a second cryptographic signature associated with the first data (the second cryptographic signature being generated utilizing the private key associated with the owner or administrator of the IT infrastructure).

In some embodiments, the claims section 620 may store delegated access privilege data (i.e., access privilege claims) associated with the data stored in the data section 610. By way of a non-limiting example, the IT infrastructure owner can provide access privilege claims to enable delegated access to the data associated with the IT infrastructure owned by the IT infrastructure owner. In the embodiments shown in FIG. 3, the claims section 620 may contain a claim 622 signed by the private key K2 324 of the owner 320. The claim 622 can permit the auditor 330, identifiable based on the public key K1 332 of the auditor 330, to access data generated and signed by the device 310, identifiable based on the public key K1 312 of the device 310.

Although a specific embodiment for a datastore suitable for carrying out the various steps, processes, methods, and operations described herein is discussed with respect to FIG. 6, any of a variety of systems and/or processes may be utilized in accordance with embodiments of the disclosure. For example, additional security measures such as encryption or hashing can be incorporated into the data storage process to further enhance data security. The elements depicted in FIG. 6 may also be interchangeable with other elements of FIGS. 1-5 and 7-12 as required to realize a particularly desired embodiment.

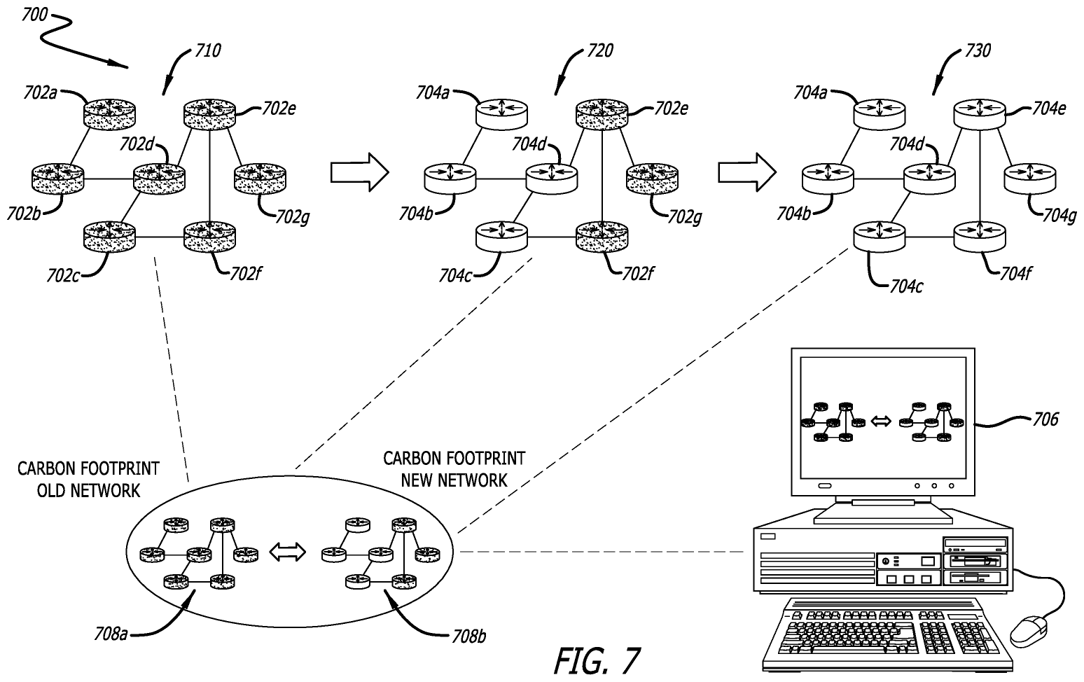

Referring to FIG. 7, a diagram 700 illustrating the process of assessing the carbon footprint of an IT infrastructure during device migration in accordance with various embodiments of the disclosure is shown. The diagram 700 may be divided into three distinct stages: the initial infrastructure 710 with old devices, the infrastructure 720 in transition, and the renewed infrastructure 730. In many embodiments, the initial infrastructure 710 may be equipped with old devices 702a-g. Through the system 706, the network/IT administrator may have the ability to view the carbon footprint 708a of the initial infrastructure 710 with these old devices. The initial assessment can provide a baseline for the carbon footprint before the renewal process commences, enabling the administrator to make informed decisions based on “live”, aggregated, and anonymized power consumption data and carbon footprint metrics.

In a number of embodiments, the infrastructure 720 in transition can feature a mix of new devices 704a-d and remaining old devices 702e-g. Via the system 706, the administrator can monitor the carbon footprint 708b of the infrastructure 720 during this transitional phase. The real-time data can provide valuable insights into the carbon footprint during the migration process, allowing for adjustments and optimizations to be made.

In a variety of embodiments, the renewed infrastructure 730 may be composed entirely of new devices 704a-g. Through the system 706, the administrator can evaluate the carbon footprint of the renewed infrastructure 730. The final assessment can allow the administrator to gauge the effectiveness of the renewal process in reducing the carbon footprint, thereby facilitating strategic decisions about infrastructure evolution to improve business efficiency.

This migration process may shift the concept from “replacement” to “renewal” in terms of combined hardware, software, and environmental context. The system can allow for the secure and efficient management of carbon-related metrics of IT devices in operation, enabling various stakeholders, including IT infrastructure owners, auditors, and generic users, to make informed decisions based on trustworthy and actionable comparisons and data.

The initial proposal may be to approach the renewal with a complete device/equipment replacement, and to prove the lower carbon footprint of the renewed infrastructure compared with the old infrastructure based on live data. The replacement of a single device, however, may not happen in a completely matched manner (e.g., increased port density and new transceiver generations can reduce the form factor on the new equipment; increased compute capacity can reshape the architecture itself; or newer software features may contribute to carbon footprint reduction, etc.). Accordingly, the concept can be shifted from “replacement” to “renewal” in terms of combined hardware, software, and environmental context.

In some embodiments, a delegated user may be presented with just key performance indicators (KPIs) without the underlying identifiable data being shared, so that anonymity can be preserved. Trustworthiness may be guaranteed by digital (cryptographic) signatures by multiple parties associated with the provided data. The KPIs may translate into different actionable items from different perspectives. By way of non-limiting examples, the IT infrastructure owner may rethink the deployment, tune the design, or take a strategic decision about infrastructure evolution to improve on such KPI and/or business efficiency. A generic delegated user can support the owner in the business decision while using a special key to access disaggregated data. An auditor may be able to disaggregate the available data, to a certain depth, and can certify the fulfillment of the requirement for which the IT infrastructure is audited. Further, a generic user with no disaggregation permission can benchmark the industry parameters and/or compare different vendors.

Although a specific embodiment for an infrastructure carbon footprint assessment during device migration suitable for carrying out the various steps, processes, methods, and operations described herein is discussed with respect to FIG. 7, any of a variety of systems and/or processes may be utilized in accordance with embodiments of the disclosure. For example, the system can be enhanced with machine learning algorithms to predict the potential carbon footprint based on the type and number of devices being replaced. The elements depicted in FIG. 7 may also be interchangeable with other elements of FIGS. 1-6 and 8-12 as required to realize a particularly desired embodiment.

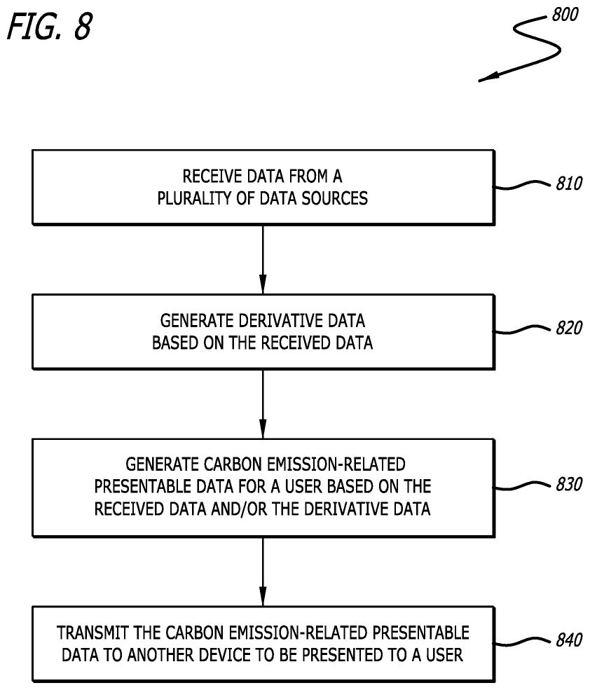

Referring to FIG. 8, a flowchart showing a process 800 for generating and transmitting carbon emission-related data in accordance with various embodiments of the disclosure is shown. In many embodiments, the process 800 may receive data from a plurality of data sources (block 810). The data sources can include various devices within an IT infrastructure, energy providers, or any other relevant sources. The received data can encompass a wide range of metrics, such as power consumption, operational status, and energy source details. The data received from the various devices may include carbon-related metrics.

In a number of embodiments, the process 800 may generate derivative data based on the received data (block 820). This can involve processing and analyzing the received data to derive additional insights or metrics. By way of a non-limiting example, the derivative data may include aggregated data that combines metrics from multiple devices or energy providers, or statistical data (e.g., maximum, and minimum metrics and/or patterns) that provides a summary or trend analysis of the received data.

In a variety of embodiments, the process 800 may generate carbon emission-related presentable data for a user based on the received data and/or the derivative data (block 830). The presentable data can be in a format that is easy for the user to understand and interpret, such as graphs, charts, or tables. By way of non-limiting examples, the presentable data may provide a comprehensive view of the carbon footprint of the IT infrastructure, including both overall metrics and detailed breakdowns by device, energy provider, or other relevant categories.

In some embodiments, the process 800 may transmit the carbon emission-related presentable data to another device to be presented to the user (block 840). This may involve sending the data over a network to a user device, such as a computer or mobile device. The user can then view the presentable data on the device, enabling the user to monitor the carbon footprint of the IT infrastructure and make informed decisions about the environmental sustainability efforts.

Although a specific embodiment for generating and transmitting carbon emission-related data suitable for carrying out the various steps, processes, methods, and operations described herein is discussed with respect to FIG. 8, any of a variety of systems and/or processes may be utilized in accordance with embodiments of the disclosure. For example, the system may incorporate advanced data analytics capabilities to identify trends or anomalies in the carbon footprint data, providing users with predictive insights or alerts about potential issues. The elements depicted in FIG. 8 may also be interchangeable with other elements of FIGS. 1-7 and 9-12 as required to realize a particularly desired embodiment.

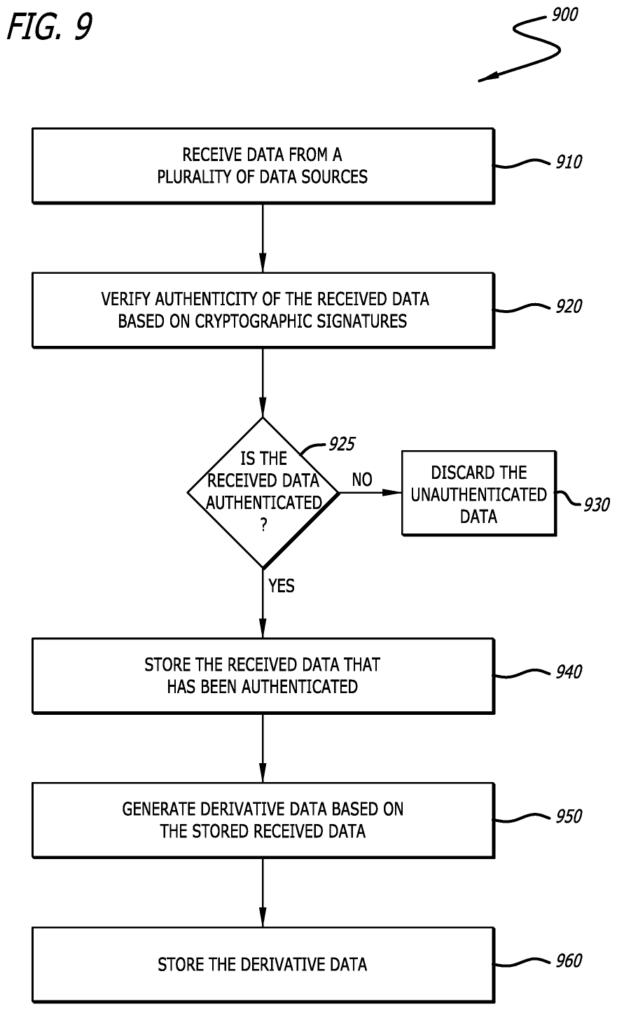

Referring to FIG. 9, a flowchart showing a process 900 for receiving, verifying, and storing data in accordance with various embodiments of the disclosure is shown. In many embodiments, the process 900 may receive data from a plurality of data sources (block 910). The data sources can include various devices within an IT infrastructure, energy providers, or any other relevant sources. The received data can encompass a wide range of metrics, such as power consumption, operational status, and energy source details.

In a number of embodiments, the process 900 may verify the authenticity of the received data based on cryptographic signatures (block 920). This can involve verifying the cryptographic signatures associated with the received data based on public keys of the purported data sources. Verifying the authenticity of the received data may ensure that the data is genuine and has not been tampered with. Therefore, the reliability and trustworthiness of the data can be enhanced.

In a variety of embodiments, the process 900 can determine if the received data is authenticated (block 925). In some embodiments, in response to the data being authenticated, the process 900 can store the received data that has been authenticated. However, in more embodiments, when the data is not authenticated, the process 900 can discard the unauthenticated data.

In additional embodiments, in response to the data being authenticated, the process 900 may store the received data that has been authenticated (block 940). The authenticated data can be stored in a datastore. The datastore may be associated with a distributed PKI. In particular, the datastore can include a data section and a claims section.

In further embodiments, the process 900 may generate derivative data based on the stored received data (block 950). This can involve processing and analyzing the received data to derive additional insights or metrics. By way of a non-limiting example, the derivative data may include aggregated data that combines metrics from multiple devices or energy providers, or statistical data (e.g., maximum, and minimum metrics and/or patterns) that provides a summary or trend analysis of the received data.

In still more embodiments, the process 900 may store the derivative data (block 960). This can involve saving the derivative data in the datastore. The stored derivative data can be accessed and utilized for various purposes, such as, but not limited to, generating reports, conducting analyses, or informing decision-making processes.

In still further embodiments, when the data is not authenticated (i.e., when the data fails to be authenticated), the process 900 may discard the unauthenticated data (block 930). Discarding the unauthenticated data can involve deleting the data from the system. Discarding unauthenticated data may help to maintain the integrity of the data and prevent the use of inaccurate or fraudulent data.

Although a specific embodiment for a process of receiving, verifying, and storing data suitable for carrying out the various steps, processes, methods, and operations described herein is discussed with respect to FIG. 9, any of a variety of systems and/or processes may be utilized in accordance with embodiments of the disclosure. For example, the system can support different types of cryptographic algorithms. The elements depicted in FIG. 9 may also be interchangeable with other elements of FIGS. 1-8 and 10-12 as required to realize a particularly desired embodiment.

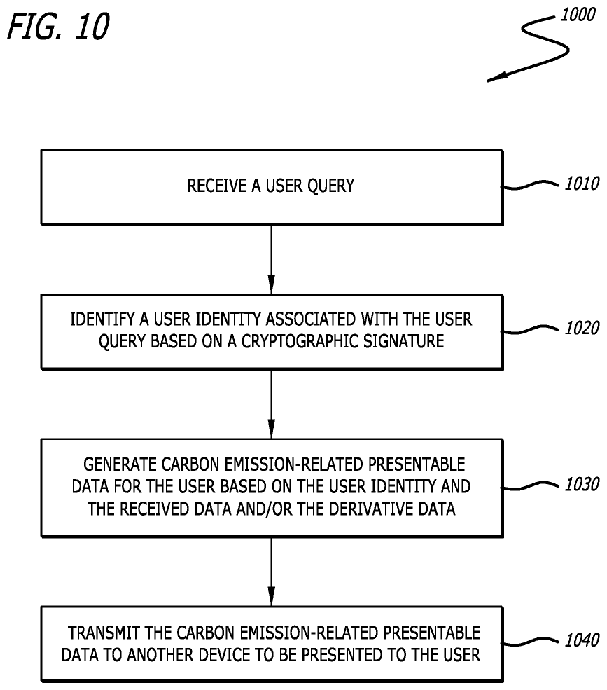

Referring to FIG. 10, a flowchart showing a process 1000 for generating and transmitting carbon emission-related data based on a user identity in accordance with various embodiments of the disclosure is shown. In many embodiments, the process 1000 may receive a user query from a user device (block 1010). The query can request specific data related to the carbon footprint of the IT infrastructure, such as the total carbon emissions, the carbon emissions of a specific device, or the carbon emissions over a specific time period.

In a number of embodiments, the process 1000 may identify a user identity associated with the user query based on a cryptographic signature (block 1020). This can involve verifying the signature associated with the user query utilizing cryptographic algorithms and based on the public key associated with the user. This operation may help to prevent unauthorized access to the data. The access privilege associated with the user can be ascertained by checking the claims section of the datastore.

In a variety of embodiments, the process 1000 may generate carbon emission-related presentable data for the user based on the user identity and the received data and/or the derivative data (block 1030). This can involve retrieving the relevant data from the datastore, processing the data (e.g., disaggregating the data) to generate the presentable data. The presentable data may be personalized based on the user identity, providing the user with tailored insights and recommendations while ensuring the user is not accessing any data for which the user does not have the appropriate access privilege.

In some embodiments, the process 1000 may transmit the carbon emission-related presentable data to another device to be presented to the user (block 1040). This can involve sending the data over a network to a user device, such as a computer or mobile device. The user can then view the presentable data on the user device, enabling the user to monitor the carbon footprint of the IT infrastructure and make informed decisions about the environmental sustainability efforts.

Although a specific embodiment for generating and transmitting carbon emission-related data based on a user identity suitable for carrying out the various steps, processes, methods, and operations described herein is discussed with respect to FIG. 10, any of a variety of systems and/or processes may be utilized in accordance with embodiments of the disclosure. For example, the system can incorporate user profiling capabilities to provide personalized recommendations based on the user's past queries or preferences. The elements depicted in FIG. 10 may also be interchangeable with other elements of FIGS. 1-9, 11, and 12 as required to realize a particularly desired embodiment.

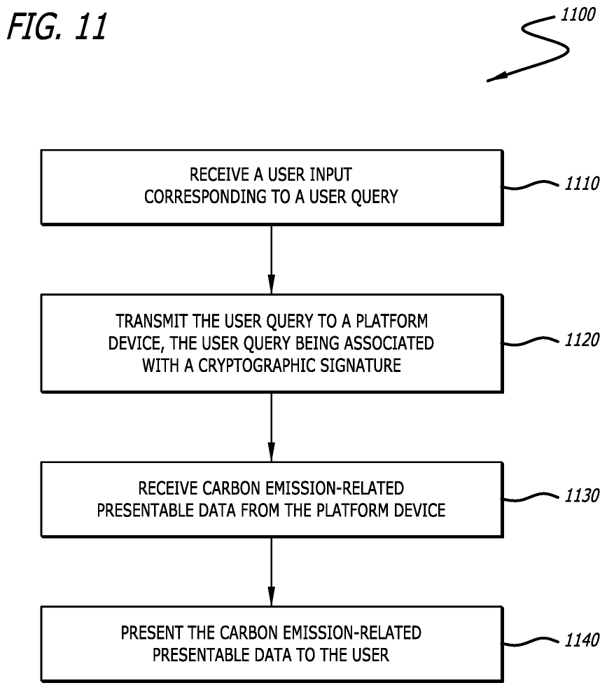

Referring to FIG. 11, a flowchart showing a process 1100 for responding to a user query and presenting carbon emission-related data in accordance with various embodiments of the disclosure is shown. In many embodiments, the process 1100 may receive a user input corresponding to a user query (block 1110). The input can be provided by the user through a user interface, such as a web portal or a mobile app. The user input may specify the type of data that the user wishes to retrieve, such as, but not limited to, the total carbon emissions, the carbon emissions of a specific device, or the carbon emissions over a specific time period.

In a number of embodiments, the process 1100 may transmit the user query to a platform device (e.g., a network device), with the user query being associated with a cryptographic signature (block 1120). This can involve sending the query over a network to a server or other platform device that hosts the relevant data and processing modules. The cryptographic signature can ensure the authenticity of the query, and can help to prevent unauthorized data access.

In a variety of embodiments, the process 1100 may receive carbon emission-related presentable data from the platform device (block 1130). This can involve receiving the data over the network. The received data may relate to metrics requested in the user query, as well as any additional data or insights generated by the platform.

In some embodiments, the process 1100 may present the carbon emission-related presentable data to the user (block 1140). This can involve displaying the data on a user interface, such as a web page or a mobile app. The data may be presented in a user-friendly format, such as, but not limited to, graphs, charts, or tables, making it easy for the user to understand and interpret the data.

Although a specific embodiment for responding to a user query and presenting carbon emission-related data suitable for carrying out the various steps, processes, methods, and operations described herein is discussed with respect to FIG. 11, any of a variety of systems and/or processes may be utilized in accordance with embodiments of the disclosure. For example, the system can support real-time data updates, allowing users to receive the most current and accurate carbon footprint data. The elements depicted in FIG. 11 may also be interchangeable with other elements of FIGS. 1-10 and 12 as required to realize a particularly desired embodiment.

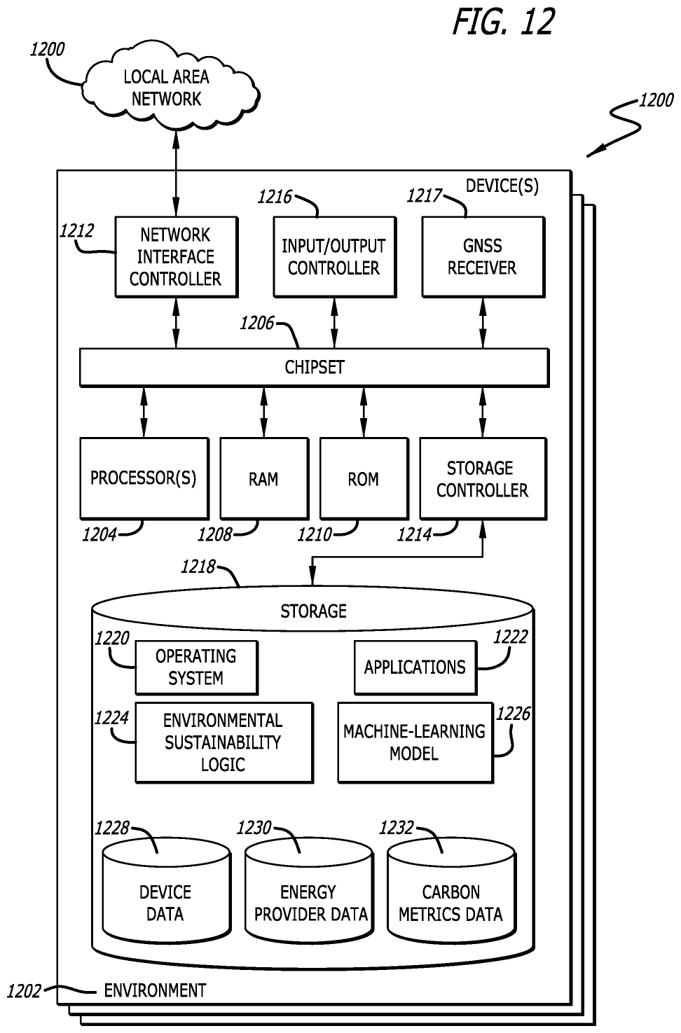

Referring to FIG. 12, a conceptual block diagram for one or more devices 1200 capable of executing components and logic for implementing the functionality and embodiments described above is shown. The embodiment of the conceptual block diagram depicted in FIG. 12 can illustrate a conventional server computer, workstation, desktop computer, laptop, tablet, network appliance, e-reader, smartphone, or other computing device, and can be utilized to execute any of the application and/or logic components presented herein. The device 1200 may, in some examples, correspond to physical devices or to virtual resources described herein.

In many embodiments, the device 1200 may include an environment 1202 such as a baseboard or “motherboard,” in physical embodiments that can be configured as a printed circuit board with a multitude of components or devices connected by way of a system bus or other electrical communication paths. Conceptually, in virtualized embodiments, the environment 1202 may be a virtual environment that encompasses and executes the remaining components and resources of the device 1200. In more embodiments, one or more processors 1204, such as, but not limited to, central processing units (“CPUs”) can be configured to operate in conjunction with a chipset 1206. The processor(s) 1204 can be standard programmable CPUs that perform arithmetic and logical operations necessary for the operation of the device 1200.

In additional embodiments, the processor(s) 1204 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In certain embodiments, the chipset 1206 may provide an interface between the processor(s) 1204 and the remainder of the components and devices within the environment 1202. The chipset 1206 can provide an interface to a random-access memory (“RAM”) 1208, which can be used as the main memory in the device 1200 in some embodiments. The chipset 1206 can further be configured to provide an interface to a computer-readable storage medium such as a read-only memory (“ROM”) 1210 or non-volatile RAM (“NVRAM”) for storing basic routines that can help with various tasks such as, but not limited to, starting up the device 1200 and/or transferring information between the various components and devices. The ROM 1210 or NVRAM can also store other application components necessary for the operation of the device 1200 in accordance with various embodiments described herein.

Different embodiments of the device 1200 can be configured to operate in a networked environment using logical connections to remote computing devices and computer systems through a network, such as the network 1240. The chipset 1206 can include functionality for providing network connectivity through a network interface card (“NIC”) 1212, which may comprise a gigabit Ethernet adapter or similar component. The NIC 1212 can be capable of connecting the device 1200 to other devices over the network 1240. It is contemplated that multiple NICs 1212 may be present in the device 1200, connecting the device to other types of networks and remote systems.

In further embodiments, the device 1200 can be connected to a storage 1218 that provides non-volatile storage for data accessible by the device 1200. The storage 1218 can, for example, store an operating system 1220, applications 1222, device data 1228, energy provider data 1230, and carbon metrics data 1232, which are described in greater detail below. The storage 1218 can be connected to the environment 1202 through a storage controller 1214 connected to the chipset 1206. In certain embodiments, the storage 1218 can consist of one or more physical storage units. The storage controller 1214 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The device 1200 can store data within the storage 1218 by transforming the physical state of the physical storage units to reflect the information being stored. The specific transformation of physical state can depend on various factors. Examples of such factors can include, but are not limited to, the technology used to implement the physical storage units, whether the storage 1218 is characterized as primary or secondary storage, and the like.

For example, the device 1200 can store information within the storage 1218 by issuing instructions through the storage controller 1214 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 1200 can further read or access information from the storage 1218 by detecting the physical states or characteristics of one or more particular locations within the physical storage units.

In addition to the storage 1218 described above, the device 1200 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 1200. In some examples, the operations performed by a cloud computing network, and or any components included therein, may be supported by one or more devices similar to device 1200. Stated otherwise, some or all of the operations performed by the cloud computing network, and or any components included therein, may be performed by one or more devices 1200 operating in a cloud-based arrangement.

By way of example, and not limitation, computer-readable storage media can include volatile and non-volatile, removable, and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 1218 can store an operating system 1220 utilized to control the operation of the device 1200. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 1218 can store other system or application programs and data utilized by the device 1200.

In various embodiment, the storage 1218 or other computer-readable storage media is encoded with computer-executable instructions which, when loaded into the device 1200, may transform it from a general-purpose computing system into a special-purpose computer capable of implementing the embodiments described herein. These computer-executable instructions may be stored as application 1222 and transform the device 1200 by specifying how the processor(s) 1204 can transition between states, as described above. In some embodiments, the device 1200 has access to computer-readable storage media storing computer-executable instructions which, when executed by the device 1200, perform the various processes described above with regard to FIGS. 1-11. In more embodiments, the device 1200 can also include computer-readable storage media having instructions stored thereupon for performing any of the other computer-implemented operations described herein.

In still further embodiments, the device 1200 can also include one or more input/output controllers 1216 for receiving and processing input from a number of input devices, such as a keyboard, a mouse, a touchpad, a touch screen, an electronic stylus, or other type of input device. Similarly, an input/output controller 1216 can be configured to provide output to a display, such as a computer monitor, a flat panel display, a digital projector, a printer, or other type of output device. Those skilled in the art will recognize that the device 1200 might not include all of the components shown in FIG. 12, and can include other components that are not explicitly shown in FIG. 12, or might utilize an architecture completely different than that shown in FIG. 12.

As described above, the device 1200 may support a virtualization layer, such as one or more virtual resources executing on the device 1200. In some examples, the virtualization layer may be supported by a hypervisor that provides one or more virtual machines running on the device 1200 to perform functions described herein. The virtualization layer may generally support a virtual resource that performs at least a portion of the techniques described herein.

In many embodiments, the device 1200 can include an environmental sustainability logic 1224. The environmental sustainability logic 1224 may process and analyze data related to the carbon footprint of IT infrastructures. The environmental sustainability logic 1224 can enable real-time monitoring and management of power consumption and carbon emissions, contributing to the overall environmental sustainability of IT operations.

In a number of embodiments, the storage 1218 can include device data 1228. The device data 1228 may relate to various IT devices within the infrastructure. The device data 1228 can include metrics such as, but not limited to, power consumption and operational status. The device data 1228 can be utilized in the assessment of the carbon footprint and optimization of the environmental sustainability of the IT operations.

In various embodiments, the storage 1218 can include energy provider data 1230. The energy provider data 1230 may relate to the energy suppliers powering the IT infrastructure. The energy provider data 1230 can include details about the source of energy and its carbon footprint, and can play an important role in accurately calculating the overall environmental impact of the IT operations.

In still more embodiments, the storage 1218 can include carbon metrics data 1232. The carbon metrics data 1232 may encompass the calculated values related to the carbon footprint of the IT infrastructure. The carbon metrics data 1232 can provide a quantifiable measure of the environmental impact of the IT operations, aiding in the assessment and optimization of sustainability efforts.

Finally, in many embodiments, data may be processed into a format usable by a machine-learning model 1226 (e.g., feature vectors), and or other pre-processing techniques. The machine-learning (“ML”) model 1226 may be any type of ML model, such as supervised models, reinforcement models, and/or unsupervised models. The ML model 1226 may include one or more of linear regression models, logistic regression models, decision trees, Naïve Bayes models, neural networks, k-means cluster models, random forest models, and/or other types of ML models 1226. The ML model 1226 may be configured to analyze the device data and energy provider data, predict future carbon emissions based on current usage patterns, and/or suggest optimal strategies for reducing the carbon footprint of the IT infrastructure.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A network device, comprising:
a processor;
at least one network interface controller configured to provide access to a network; and
a memory communicatively coupled to the processor, wherein the memory comprises environmental sustainability logic that is configured to:
receive data from a plurality of data sources, the plurality of data sources including one or more devices of an information technology (IT) infrastructure;
generate derivative data based at least in part on the received data;
generate carbon emission-related presentable data for a user based on the received data and/or the derivative data; and
transmit the carbon emission-related presentable data to another device to be presented to the user.

2. The network device of claim 1, wherein the received data includes first data associated with a first device in the one or more devices, and the environmental sustainability logic is further configured to verify authenticity of the first data based on a first public key associated with the first device and a first cryptographic signature associated with the first data.

3. The network device of claim 2, wherein the environmental sustainability logic is further configured to verify the authenticity of the first data based on a second public key associated with an owner or administrator of the IT infrastructure and a second cryptographic signature associated with the first data.

4. The network device of claim 3, wherein the environmental sustainability logic is further configured to discard the first data in response to failing to verify the authenticity of the first data.

5. The network device of claim 3, wherein the environmental sustainability logic is further configured to store the first data in a datastore in response to successfully verifying the authenticity of the first data.

6. The network device of claim 5, wherein the derivative data is generated based at least in part on the first data, and the environmental sustainability logic is further configured to store the derivative data in the datastore.

7. The network device of claim 5, wherein the datastore is associated with a distributed public key infrastructure.

8. The network device of claim 5, wherein the datastore includes a data section and a claims section.

9. The network device of claim 2, wherein the first data includes one or more carbon-related metrics associated with the first device.

10. The network device of claim 1, wherein the received data includes second data associated with at least one power source for the IT infrastructure.

11. The network device of claim 1, wherein the derivative data includes aggregated data.

12. The network device of claim 11, wherein the aggregated data is associated with aggregation based on at least one of the one or more devices, one or more network layers, one or more geographical areas, or one or more power source types.

13. The network device of claim 11, wherein the derivative data further includes one or more statistics associated with the aggregated data.

14. The network device of claim 11, wherein the aggregated data is anonymized.

15. The network device of claim 1, wherein the environmental sustainability logic is further configured to:
receive a user query associated with the user; and
identify an identity of the user based at least in part on a public key associated with the user, and wherein the carbon emission-related presentable data is generated for the user based further on the identified identity of the user.

16. The network device of claim 15, wherein the identity of the user corresponds to an owner or administrator of the IT infrastructure.

17. The network device of claim 15, wherein the identity of the user corresponds to a delegated user, and the delegated user is permitted delegated access to the carbon emission-related presentable data based on an access privilege claim signed utilizing a private key of an owner or administrator of the IT infrastructure.

18. The network device of claim 15, wherein the carbon emission-related presentable data includes disaggregated data associated with disaggregation based on the identity of the user.

19. A user device, comprising:
a processor;
at least one network interface controller configured to provide access to a network; and
a memory communicatively coupled to the processor, wherein the memory comprises environmental sustainability logic that is configured to:
receive a user input corresponding to a user query from a user;
transmit the user query to a network device, the user query being associated with a cryptographic signature;
receive carbon emission-related presentable data from the network device; and
present the carbon emission-related presentable data to the user.

20. A method for providing carbon emission data, comprising:
receiving data from a plurality of data sources, the plurality of data sources including one or more devices of an information technology infrastructure;
generating derivative data based at least in part on the received data;
generating carbon emission-related presentable data for a user based on the received data and/or the derivative data; and
transmitting the carbon emission-related presentable data to another device to be presented to the user.
